(19) United States
(12) Patent Application Publication
(10) Pub. No.: US 2026/0093009 A1
(43) Pub. Date: Apr. 2, 2026

(54) RADAR DEVICE, RADAR CONTROL METHOD, AND NON-TRANSITORY COMPUTER READABLE MEDIUM

(71) Applicant: DENSO CORPORATION, Kariya-city (JP)

(72) Inventors: Yasuhiro IDE, Kariya-city (JP); Tatsuya ENAMI, Kariya-city (JP); Yukou MURASE, Kariya-city (JP); Osamu ISAJI, Kariya-city (JP)

(21) Appl. No.: 19/413,884

(22) Filed: Dec. 9, 2025

Related U.S. Application Data
(63) Continuation of application No. PCT/JP2024/020359, filed on Jun. 4, 2024.

(30) Foreign Application Priority Data
Jun. 12, 2023 (JP) 2023-096455

(51) Int. Cl. G01S 7/35

(52) U.S. Cl. CPC G01S 7/35

(57) ABSTRACT

A radar device comprises at least one of a circuit and a processor with a memory containing executable program code. The device transmits, in each cycle, signal sets each with at least one chirp signal, whose center frequency monotonically changes and whose transmission interval varies linearly over time. The device acquires data of reflected chirp signals from targets in the environment. A frequency rate of change is defined as the relative change in center frequency versus a reference, while a time rate of change is defined as the relative change in interval versus a reference. The ratio change rate denotes the change ratio between these rates. The transmission of signal sets is regulated so that the ratio change rate remains within an allowable range during a designated time period.

### CROSS REFERENCE TO RELATED APPLICATIONS

The present application is a continuation application of International Patent Application No. PCT/JP2024/020359 filed on Jun. 4, 2024, which designated the U.S. and claims the benefit of priority from Japanese Patent Application No. 2023-096455 filed on Jun. 12, 2023. The entire disclosures of all of the above applications are incorporated herein by reference.

### TECHNICAL FIELD

The present disclosure relates to radar technology.

### BACKGROUND

Conventional radar systems transmit chirp signals while varying center frequency, and acquire the chirp signals reflected by a target as received signals.

### SUMMARY

According to at least one embodiment, a radar device includes at least one of (i) a circuit and (ii) a processor with a memory storing computer program code executable by the processor. The at least one of the circuit and the processor may have a function to, in each transmission cycle, transmit signal sets, where each signal set includes at least one chirp signal whose frequency varies over time. The at least one of the circuit and the processor also may transmit the signal sets in such a way that, for each signal set, a center frequency of the chirp signal changes monotonically and a time interval between the signal sets varies linearly over time. The at least one of the circuit and the processor further acquires reception data of a reflected signal, where the reflected signal is a chirp signal that has been reflected by a target in an external environment. A relative rate of change in the center frequency with respect to a reference frequency is defined as a frequency rate of change. A relative rate of change in the time interval with respect to a reference interval is defined as a time rate of change. A relative rate of change in the time rate of change with respect to the frequency rate of change is defined as a ratio change rate. The signal set transmission may include adjusting the center frequency for each signal set so that the ratio change rate remains within an allowable range during a specific time period.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic diagram illustrating an overall configuration of a radar device according to a first embodiment.

FIG. 2 is a block diagram illustrating a functional configuration of a control unit according to the first embodiment.

FIG. 3 is a flowchart illustrating a radar control flow according to the first embodiment.

FIG. 4 is a graph illustrating an example of chirp signals according to the first embodiment.

FIG. 5 is a graph illustrating an example of variation in time intervals for each chirp signal.

FIG. 6 is a graph illustrating an example of variation in center frequency for each chirp signal.

FIG. 7 is a graph illustrating an example of a relative rate of change for each chirp signal.

FIG. 8 is a graph illustrating an example of chirp signals according to a second embodiment.

FIG. 9 is a graph illustrating an example of chirp signals according to a third embodiment.

FIG. 10 is a graph illustrating an example of chirp signals according to a fourth embodiment.

FIG. 11 is a graph illustrating an example of chirp signals according to a fifth embodiment.

### DETAILED DESCRIPTION

To begin with, examples of relevant techniques will be described.

A conventional radar system transmits chirp signals while varying a center frequency, and acquires the chirp signals reflected by a target as received signals. In frequency analysis of a beat signal obtained by mixing the transmitted signal and the received signal, when the center frequency of the chirp signal varies, a term appears in the beat signal frequency that depends on a product of the center frequency of the chirp signal and a transmission time point. When this term becomes nonlinear with respect to a sequence number of the chirp signals, a target peak broadens. The radar system adjusts the time intervals of the chirp signals so that a relative change in the time intervals is at least twice as large as the relative change in the center frequency, in order to linearize this term.

However, in a comparative example radar system, it may be necessary to perform time adjustments with higher precision than what can be achieved by an IC (Integrated Circuit) in the radar system. In this case, it may be necessary to adjust parameters other than the time interval of the chirp signals in order to achieve the required time interval. Therefore, in the comparative example radar system, there is a possibility that the constraints on parameters other than the time interval of the chirp signals become more stringent in order to reduce peak broadening.

In contrast to the comparative example, according to a radar device, a radar control method, and a radar control program of the present disclosure, peak broadening can be reduced, and constraints on chirp signals can be reduced.

According to a first aspect of the present disclosure, a radar device includes at least one of (i) a circuit and (ii) a processor with a memory storing computer program code executable by the processor. The at least one of the circuit and the processor has a function to, in each transmission cycle, transmit signal sets, where each signal set includes at least one chirp signal whose frequency varies over time. The at least one of the circuit and the processor also transmits the signal sets in such a way that, for each signal set, a center frequency of the chirp signal changes monotonically and a time interval between the signal sets varies linearly over time. The at least one of the circuit and the processor further acquires reception data of a reflected signal, where the reflected signal is a chirp signal that has been reflected by a target in an external environment. A relative rate of change in the center frequency with respect to a reference frequency is defined as a frequency rate of change. A relative rate of change in the time interval with respect to a reference interval is defined as a time rate of change. A relative rate of change in the time rate of change with respect to the frequency rate of change is defined as a ratio change rate. The signal set transmission includes adjusting the center frequency for each signal set so that the ratio change rate remains within an allowable range during a specific time period.

The above-described aspect may be implemented as a method or as a program.

According to this configuration, the center frequency of the chirp signal is adjusted so that the ratio change rate falls within the allowable range during the specific time period. Therefore, it is possible to avoid the product of the time interval and the center frequency of the chirp signal from becoming nonlinear within the specific time period. Since the center frequency can be adjusted more finely compared to the time interval, it becomes easier for the ratio change rate to fall within the allowable range of variation by adjusting the center frequency, and the constraints on parameters other than the center frequency can be relaxed. As a result, peak broadening can be reduced, and the constraints on the chirp signal can be relaxed.

The following will describe embodiments of the present disclosure with reference to the drawings. Elements corresponding to each other among the embodiments are assigned the same numeral and their descriptions may be omitted. When only a part of a component is described in an embodiment, the other part of the component can be relied on the component of a preceding embodiment. Furthermore, in addition to combinations of components explicitly described in each embodiment, it is also possible to combine components from different embodiments, as long as the combination poses no difficulty, even if not explicitly described.

### First Embodiment

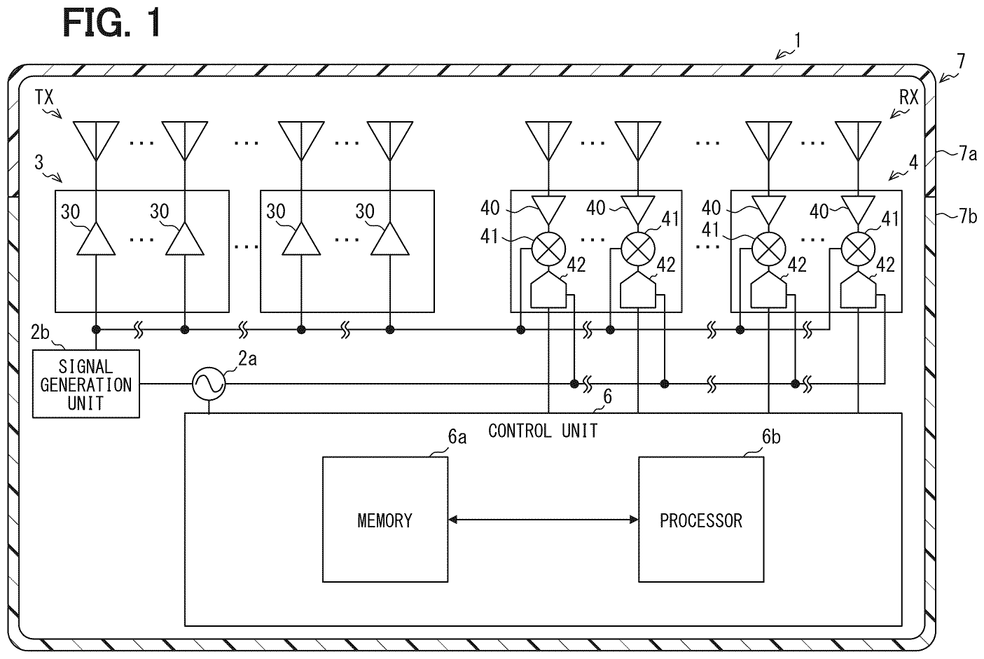

A first embodiment of the present disclosure will be described with reference to FIGS. 1 to 7. A radar device 1 is mounted on a moving object such as a vehicle. The radar device 1 transmits a transmitted signal, receives the transmitted signal reflected by an object as a received signal, and detects target information such as a distance to the target, which is the object that reflected the transmitted signal, a relative velocity to the target, and a direction of the target.

The target information output from the radar device 1 is input to an in-vehicle ECU (electronic control unit) via an in-vehicle network such as a Control Area Network (CAN) (registered trademark) or Ethernet (registered trademark). The in-vehicle ECU executes various processes for automated driving of the vehicle and advanced driving assistance based on the acquired target information of each target.

The processes based on the target information include, for example, collision avoidance processes and warning processes. The collision avoidance process is a process of controlling the vehicle to avoid collision with the target by controlling a brake system and a steering system based on the target information of each target. The warning process is a process for warning a driver of a possibility of a collision with the target based on the target information of each target.

As shown in a basic configuration of FIG. 1, the radar device 1 of the present embodiment includes a clock oscillator 2a, a signal generation unit 2b, transmission circuits 3, transmission antennas TX, reception antennas RX, receiver circuits 4, a control unit 6, and a housing unit 7. The radar device 1 is a so-called MIMO (Multiple-Input-Multiple-Output) radar that transmits transmitted signals from multiple transmission antennas TX to artificially increase the number of reception antennas RX beyond the actual number.

The clock oscillator 2a generates a periodic clock signal. The clock oscillator 2a transmits the clock signal to the signal generation unit 2b and to each of the receiver circuits 4. The signal generation unit 2b generates a modulation signal that is modulated at a modulation period corresponding to the clock signal, based on a control signal from the control unit 6. The modulated signal is, for example, a so-called chirp signal whose frequency changes over time. The modulated signal is distributed and output on each channel of the transmission circuits 3 and the receiver circuits 4. Hereinafter, the modulation signal output from the signal generation unit 2b to the transmission circuit 3 shall be referred to as a transmitted signal. In addition, the modulation signal output from the signal generation unit 2b to the receiver circuit 4 shall be referred to as a local signal.

The transmission circuits 3 and the receiver circuits 4 are each mainly composed of a semiconductor integrated circuit device such as an MMIC (Monolithic Microwave Integrated Circuit). The transmission circuits 3 are connected to the transmission antennas TX and outputs the transmitted signal to the transmission antennas TX. For example, the radar device 1 has the transmission circuits 3. A transmission circuit 3 of the transmission circuits 3 includes amplifiers 30 in the same number as the number of connected transmission antennas TX. The amplifiers 30 amplify the transmitted signal output from the signal generation unit 2b and output the amplified signals to the corresponding transmission antennas TX.

The transmission antenna TX converts an electrical signal, which is a transmitted signal supplied from the signal generation unit 2b, into a radio wave signal and transmits it to an external environment. A transmission antenna TX of the transmission antennas TX includes at least one antenna element. For example, the transmission antenna TX is a patch antenna having flat-plate-shaped antenna elements. The antenna element is provided on a dielectric substrate. The dielectric substrate has a surface on which a ground plane is provided and a surface on which the antenna element is provided. The antenna element is provided on the dielectric substrate in a position facing the ground plane. The multiple antenna elements are connected, for example, in series, by a feed line that supplies an electric signal.

A reception antenna RX of the reception antennas RX receives, as a received signal, a radio wave signal including a transmitted signal reflected from a target in the external environment as a reflecting object. The reception antenna RX is connected to a corresponding receiver circuit 4.

The reception antenna RX converts the received signal, which is a radio wave signal, into an electric signal and outputs it to the corresponding receiver circuit 4. The reception antenna RX is, for example, a patch antenna having at least one antenna element connected in series by a feeder line, similar to the transmission antenna TX.

A receiver circuit 4 of the receiver circuit 4 is connected to a reception antenna RX and acquires a received signal received by the reception antenna RX. For example, the radar device 1 has the receiver circuits 4. The receiver circuit 4 is provided with the same number of amplifiers 40 as the connected reception antennas RX, a signal mixing unit 41, and an AD converter 42.

The amplifiers 40 amplify the received signal received by the reception antenna and outputs the amplified signal to the signal mixing unit 41. The signal mixing unit 41 generates a beat signal by mixing the local signal from the signal generation unit 2b with the received signal. The generated beat signal is an interference signal that represents a frequency difference between the received signal and the local signal. The beat signal is output to the AD converter 42 after high-frequency components outside the frequency difference between the received signal and the local signal are filtered out by a low-pass filter (not shown).

The AD converter 42 converts the beat signal, which is a filtered analog signal, into a digital signal. The AD converter 42 acquires the clock signal output from the clock oscillator 2a, samples the beat signal at time intervals corresponding to the period of the clock signal, and digitizes it. The AD converter 42 sequentially outputs the digitized beat signal to the control unit 6.

The housing unit 7 is a container that accommodates the transmission antennas TX, the reception antennas RX, the clock oscillator 2a, the signal generation unit 2b, the transmission circuits 3, the receiver circuits 4, and the control unit 6. The housing unit 7 is provided with a radome 7a and a case body 7b. The radome 7a is mainly formed of a transmissive material that allows millimeter-wave radio waves to pass through. The radome 7a is attached to the case body 7b so as to cover the antennas TX and RX. The radome 7a, while protecting the antennas TX and RX, enables the transmission and reception of signals by the antennas TX and RX through the passage of radio waves. The case body 7b, together with the radome 7a, defines an accommodation space that houses the components of the above-mentioned radar device 1. A temperature sensor that detects an internal temperature may be provided within the housing unit 7. The temperature sensor has, for example, a thermistor and outputs temperature information corresponding to a resistance value of the thermistor. The temperature sensor may be configured to detect the temperature information of each transmission circuit 3 and receiver circuit 4, and output it to the control unit 6.

The control unit 6 includes at least one dedicated computer. The dedicated computer constituting the control unit 6 may be an electronic control unit (ECU) specialized for controlling the radar device 1.

The dedicated computer constituting the control unit 6 has at least one memory 6a and at least one processor 6b. The memory 6a is at least one type of non-transitory tangible storage medium out of, for example, a semiconductor memory, a magnetic medium, an optical medium, and the like that non-transitorily store a computer readable program, data, and the like. Here, the memory 6a may accumulate and retain data even when the control unit 6 is turned off, or may temporarily store data by deleting the data when the control unit 6 is turned off.

The processor 6b includes a processing core as at least one type of, for example, a CPU (i.e., Central Processing Unit), a GPU (i.e., Graphics Processing Unit), a RISC (i.e., Reduced Instruction Set Computer)-CPU, a DFP (i.e., Data Flow Processor), and a GSP (i.e., Graph Streaming Processor). The processor 6b may be at least one of a digital circuit and an analog circuit. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include the memory 6a in which a program is stored.

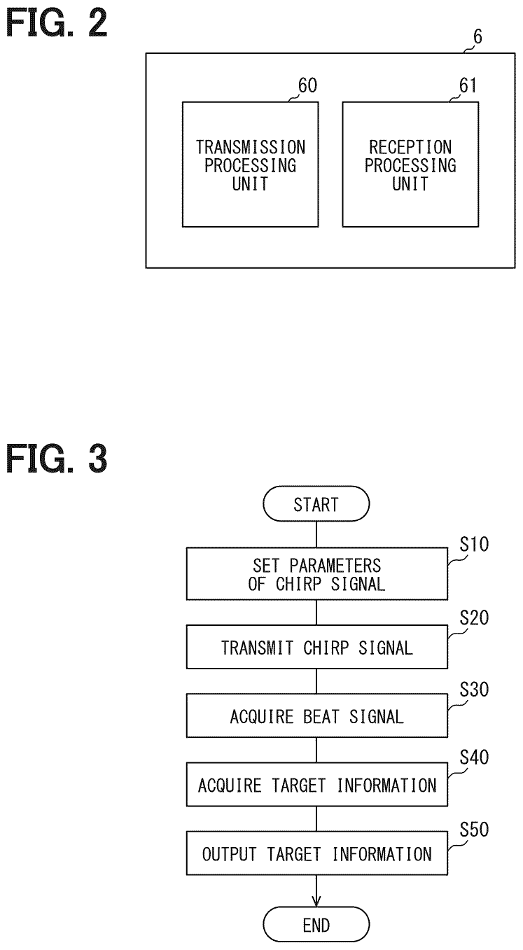

In the radar device 1, the processor 6b executes instructions included in a radar control program stored in the memory 6a in order to detect a target object (target). As a result, the radar device 1 constructs multiple functional units for controlling the radar. The multiple functional units constructed in the radar device 1 include a transmission processing unit 60 and a reception processing unit 61, as shown in FIG. 2. These functional units may also be referred to as functional blocks.

Through the cooperation of the transmission processing unit 60 and the reception processing unit 61, a radar control method by which the control unit 6 controls the radar device 1 is executed according to a radar control flow shown in FIG. 3. The radar control flow is repeatedly executed while the radar device 1 is operating. Here, in the radar control flow, “S” means steps of the process executed by instructions included in the radar control program.

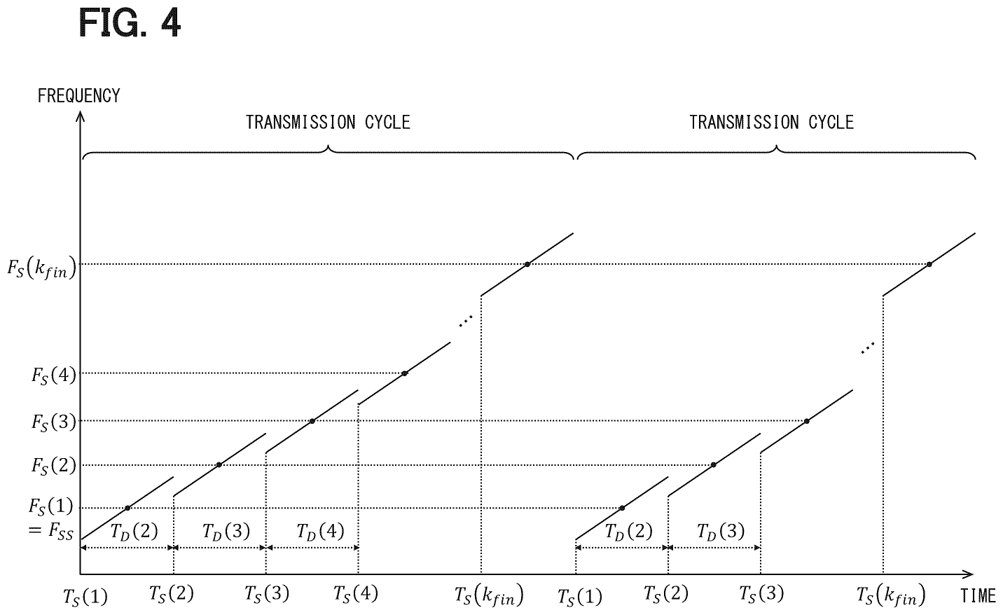

First, in S10, the transmission processing unit 60 generates and transmits a transmitted signal. The transmitted signal is a radar wave in a millimeter-wave band or a quasi-millimeter-wave band. The transmission processing unit 60 generates a chirp wave, whose frequency is temporally modulated, as a fundamental signal. More specifically, as shown in FIG. 4, the transmission processing unit 60 generates a signal in which one chirp corresponds to a waveform that varies (for example, increases gradually) from a predetermined initial frequency to a final frequency, and multiple chirps are repeated at a predetermined cycle. The transmission processing unit 60 transmits the chirp signals thus generated as the transmitted signal.

The transmission processing unit 60 generates the chirp signals in one transmission cycle. The transmission processing unit 60 sets a center frequency of the chirp signal to vary monotonically within a single transmission cycle. In an example shown in FIG. 4, the transmission processing unit 60 sets the center frequency of each chirp signal so that the center frequency increases monotonically over time within the transmission cycle. Here, the transmission cycle refers to a cycle from the start of transmission of a first chirp signal until the completion of transmission of a specified number (K_{fin}) of chirp signals.

The transmission processing unit 60 sets a time interval of the chirp signals to change linearly with respect to time and the sequence number of the chirp signals. Here, the time interval of a specific chirp signal refers to an interval between a transmission start time point of that signal and a transmission start time point of the immediately preceding chirp signal within the transmission cycle. Here, for the k-th chirp signal in a given transmission cycle, let TS (k) denote the transmission start time point, and TD(k) denote the time interval. Since only the first chirp signal does not have a preceding chirp signal, its time interval is defined as T_{DS}, which is an interval from a reference time point. T_{DS} is, for example, set to zero. When an increment per chirp signal in the time interval TD(k) is denoted as Δt, a linearly varying time interval TD(k) corresponds to the following equation (1) using T_{DS}, k, and Δt.

$$\begin{matrix}〈 Math 1 〉 & \\ {T}_{D} ( k ) = {T}_{DS} + ( k - 1 ) \cdot Δ t & ( 1 )\end{matrix}$$

Then, the transmission processing unit 60 sets the transmission start time point T_{S}(k) for the k-th chirp signal according to the following equation (2).

$$\begin{matrix}〈 Math 2 〉 & \\ {T}_{s} ( k ) = \sum {T}_{D} ( k ) & ( 2 )\end{matrix}$$

The transmission processing unit 60 is configured to transmit each of the specified number of chirp signals in one transmission cycle at time intervals T_{D}(k) and transmission start time points T_{S}(k) corresponding to the above equations. Furthermore, the transmission processing unit 60 specifies a monotonically varying center frequency as a parameter defining each chirp signal in one transmission cycle.

The transmission processing unit 60 sets the center frequency F_{S}(k) of the k-th chirp signal such that the product of FS(k) and the time interval TD(k) becomes substantially linear with respect to time and the order number of the chirp signal within a specified time range. A relative rate of change of the time interval TD(k) with respect to a reference interval is defined as a time rate of change. A relative rate of change of the center frequency with respect to a reference frequency is defined as a frequency rate of change. Here, “substantially linear” means that the relative rate of change of the time rate of change with respect to the frequency rate of change falls within an allowable range of variation. Hereinafter, the relative rate of change of the time rate of change to the frequency rate of change may be referred to as a relative rate of change (ratio change rate). Note that here, the allowable range of variation refers to a range in which the relative rate of change is less than or equal to (or less than) a specified upper threshold value and greater than or equal to (or greater than) a specified lower threshold value. In addition, the specified time range refers to a time period that is less than or equal to (or less than) a specified upper time limit and greater than or equal to (or greater than) a specified lower time limit. For example, the specified time range may refer to a time period after a predetermined time has elapsed from the start of the transmission cycle; that is, the upper time limit is the predetermined time, and the lower time limit is zero.

Here, the time rate of change A and the frequency rate of change B of the k-th chirp signal correspond to calculated values given by the following equations (3) and (4). It should be noted that the reference interval for the time rate of change A is a first time interval T_{DS}, and the reference frequency for the frequency rate of change B is a first center frequency F_{SS}.

$$\begin{matrix}〈 Math 3 〉 & \\ A = \{ {T}_{D} ( k ) - {T}_{D} ( k - 1 ) \} / {T}_{DS} & ( 3 )\end{matrix}$$

$$\begin{matrix}〈 Math 4 〉 & \\ B = \{ {F}_{S} ( k ) - {F}_{S} ( k - 1 ) \} / {F}_{SS} & ( 4 )\end{matrix}$$

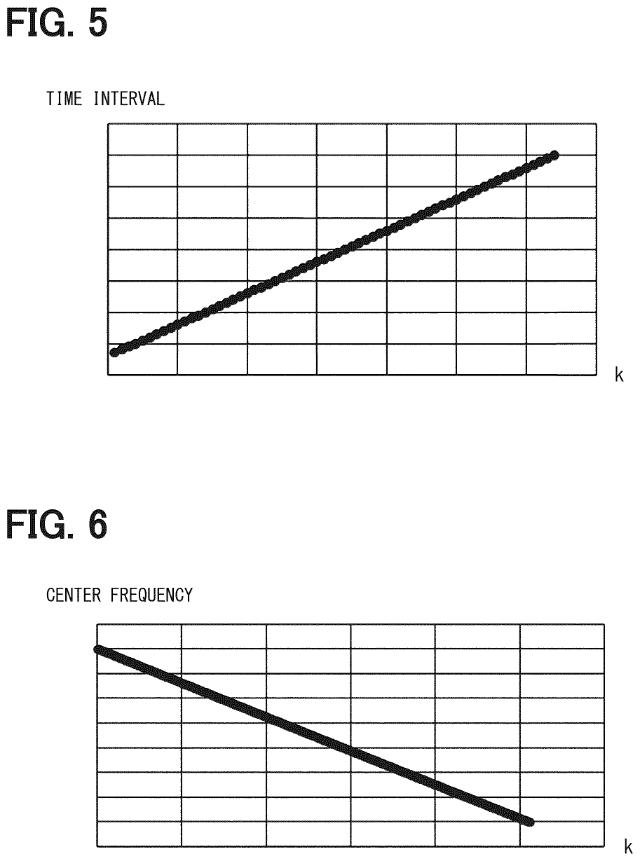

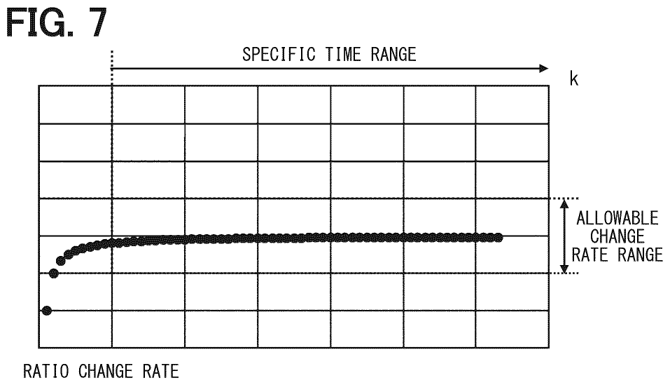

Accordingly, the relative rate of change corresponds to a value obtained by dividing a right side of equation (3) by a right side of equation (4). The transmission processing unit 60 defines the center frequency F_{S}(k) such that this relative rate of change falls within the allowable range of variation in the specified time period. For example, let us assume that the time interval T_{D}(k) exhibits a variation pattern as represented by the graph in FIG. 5. In this case, the transmission processing unit 60 varies the center frequency FS(k) for each chirp signal according to the variation pattern represented by the graph in FIG. 6, so that the relative rate of change exhibits the variation pattern represented by the graph in FIG. 7. This center frequency F_{S}(k) corresponds to a parameter expressed by the following equation (5), wherein the product of the time interval T_{D}(k), and thus the transmission start time point T_{S}(k), becomes substantially linear.

$$\begin{matrix}〈 Math 5 〉 & \\ {F}_{S} ( k ) = \frac{k \cdot {T}_{DS} \cdot {F}_{SS}}{{T}_{S} ( k )} & ( 5 )\end{matrix}$$

Here, a direction of variation in the relative rate of change from the subsequent chirp signal side to the preceding chirp signal side in each transmission cycle is only in a negative direction. That is, as shown in FIG. 7, the graph of the relative rate of change within one transmission cycle corresponds to only one branch of a hyperbola representing an inverse proportional relationship. For this reason, the transmission processing unit 60 manages the numbering of each chirp signal within one transmission cycle so that it starts from k=1.

It should be noted that the IC constituting the control unit 6 is generally capable of adjusting the time interval in units of approximately 10 ns. In addition, the IC is generally capable of adjusting the center frequency in units of fractions of a hertz.

It should be noted that, in the first embodiment, the transmission processing unit 60 generates a transmitted signal in which the time interval for each chirp signal changes linearly with respect to time and the sequence number of the chirp signal, and the center frequency changes monotonically. That is, it can be understood that the transmission processing unit 60 treats a single chirp signal as a signal set and generates a transmitted signal in which the time interval for each signal set changes linearly and the center frequency changes monotonically. It should be noted that a time period from the start to the end of transmission of a chirp signal within a transmission cycle, as well as the bandwidth, are, for example, set to be substantially the same. In addition, the transmission end time point of a preceding chirp signal and the transmission start time point of a subsequent chirp signal are set to be substantially the same.

Next, in S20, the transmission processing unit 60 receives, as a received signal, the transmitted signal that has been reflected by the target and returned. In the subsequent S30, the reception processing unit 61 acquires a beat signal corresponding to the received signal.

Then, in S40, the reception processing unit 61 acquires target information regarding the target by performing frequency analysis on the beat signal. The target information includes at least a distance between the target and the radar device 1 and a relative velocity. More specifically, the reception processing unit 61 performs two Fast Fourier Transform (FFT) processes on the beat signal. As a result, the transmission processing unit 60 acquires a two-dimensional spectrum relating to the distance and the relative velocity.

In detail, the transmission processing unit 60 first performs the FFT processing on the beat signal for each chirp. Through this first FFT processing, a frequency spectrum (distance spectrum) that shows a peak at a frequency position corresponding to the distance to the object is obtained for each chirp. The distance spectrum is data indicating the signal strength for each distance bin according to the distance resolution.

When the relative velocity with respect to the target is not zero, the distance spectra corresponding to each chirp show a peak at the same distance bin, but their phases differ from each other between chirps. This phase difference between chirps is due to changes in the distance between the radar device 1 and the target. By utilizing this, in the Fast Chirp Modulation (FCM) method, the relative velocity with respect to the target is detected. Through these two FFT processes, the transmission processing unit 60 obtains a two-dimensional spectrum with respect to the distance and the relative velocity.

More specifically, as the second FFT process, the reception processing unit 61 performs the FFT process on a waveform in which phases at each distance bin, obtained from the first FFT process for multiple chirps, are arranged in time series. As a result, a frequency spectrum (velocity spectrum) showing a peak at a position corresponding to the relative velocity with respect to the target is obtained for each velocity bin. It should be noted that, depending on a maximum detectable velocity, velocity aliasing may occur, and multiple peaks may appear in the two-dimensional spectrum.

Here, a frequency φ_{IF}(k) at a specific sampling point of each chirp signal, which can be obtained by the second FFT process, corresponds to the following equation, where “r” is the distance to the target, “v” is the velocity, and “c” is the speed of light. In the following, “Sch” is a parameter determined according to a slope of the chirp signal; it is +1 when the slope is positive and −1 when the slope is negative.

$$\begin{matrix}〈 Math 6 〉 & \\ {φ}_{IF} ( k ) = 2 π ( {s}_{ch} \cdot {F}_{S} ( k ) \cdot 2 r / c + {s}_{sh} \cdot {T}_{S} ( k ) \cdot {F}_{S} ( k ) \cdot 2 v / c ) & ( 6 )\end{matrix}$$

Here, as a result of the signal processing at the time of transmission in the transmission processing unit 60, the product of the center frequency F_{S}(k) and the time interval T_{D}(k) is substantially linear. Since the transmission start time point T_{S}(k) is the sum of the time intervals T_{D}(k) up to the k-th chirp signal, the product of the transmission start time T_{S}(k) and the center frequency F_{S}(k) is also linear. That is, the product of the center frequency F_{S}(k) and the transmission start time point T_{S}(k) in a second term of the above equation (6) is also linear. Therefore, compared to a case where this product is nonlinear, even if the target's speed increases, the broadening of the peak is more easily reduced.

The reception processing unit 61 acquires the distance and the relative velocity of the target as the target information, based on the result of the second FFT processing. In the subsequent S50, the reception processing unit 61 outputs the acquired target information. The process of outputting target information includes processing such as transmitting the target information externally and storing it on a storage medium.

It should be noted that a direction (azimuth) of the detection target can be detected based on an irradiation direction of the beam. Further, when a receiver circuit 4 includes reception antennas RX, the azimuth may be detected based on a phase difference of the received signals between the reception antennas RX. The radar device 1 outputs the detected target information to a driving control ECU (Electronic Control Unit) or the like that controls the driving of the vehicle.

According to the first embodiment described above, the center frequency of the chirp signal is adjusted so that the relative rate of change falls within the allowable range of variation during the specific time period. Therefore, it is possible to avoid the product of the time interval and the center frequency of the chirp signal from becoming nonlinear within the specific time period. Since the center frequency can be adjusted more finely compared to the time interval, it becomes easier for the relative rate of change to fall within the allowable range of variation by adjusting the center frequency, and the constraints on parameters other than the center frequency can be relaxed. As a result, peak broadening can be reduced, and the constraints on the chirp signal can be relaxed.

### Second Embodiment

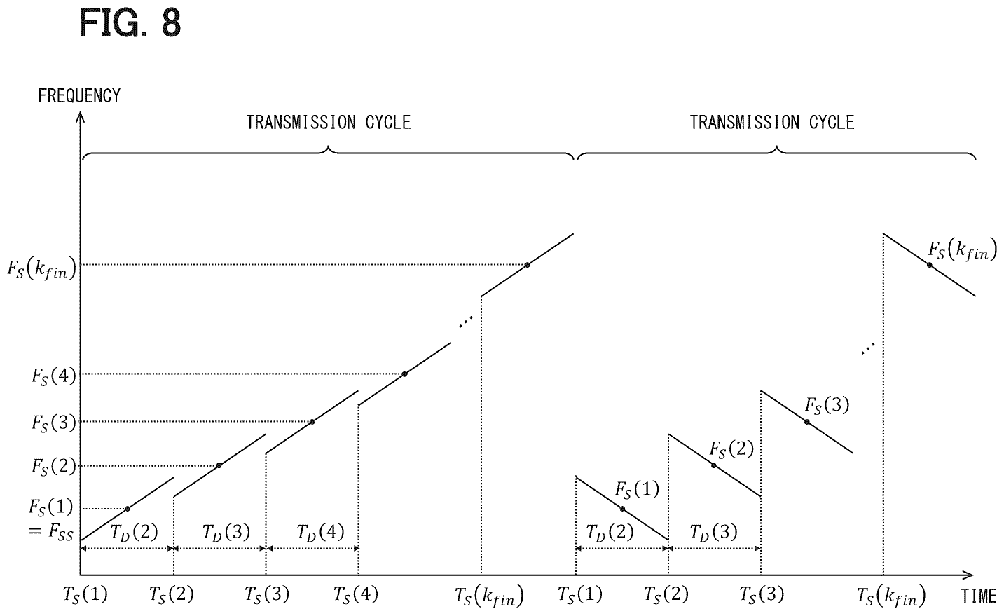

A second embodiment shown in FIG. 8 is a modification of the first embodiment.

In the second embodiment, a transmission processing unit 60 switches between an increasing change and a decreasing change in frequency over time for each chirp signal, in accordance with a transmission cycle. In other words, the transmission processing unit 60 causes the sign of a slope of the frequency change with respect to time for each chirp signal to vary according to the transmission cycle. For example, as shown in FIG. 8, the transmission processing unit 60 sets the slope of the frequency change in a positive direction in a specific transmission cycle, and switches the slope of the frequency change to a negative direction in the immediately following transmission cycle.

According to the above second embodiment, since the increase and decrease in the frequency of the chirp signal over time are switched in accordance with the transmission cycle, interference with other radar devices 1 can be reduced.

### Third Embodiment

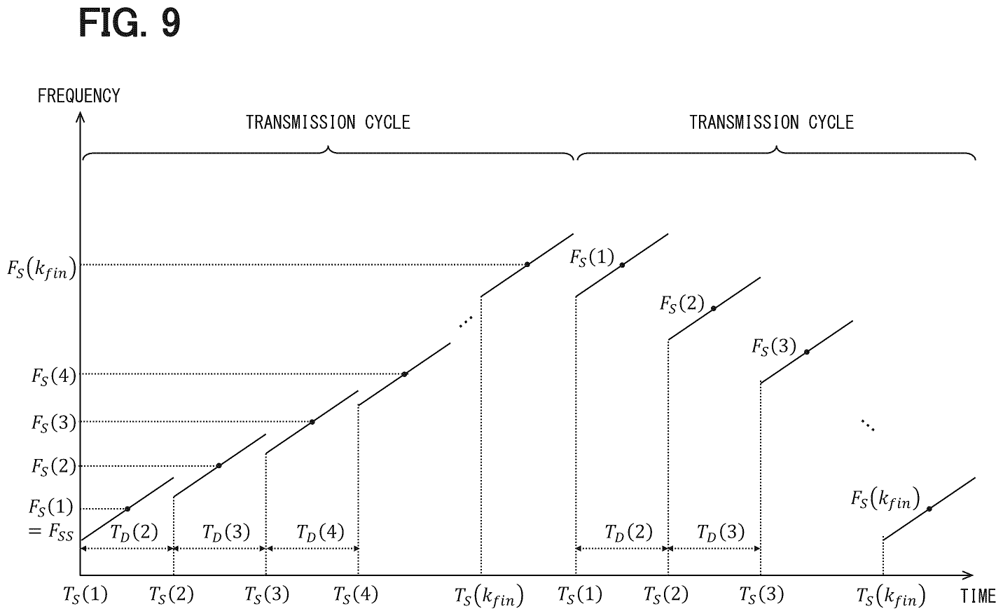

As shown in FIG. 9, a third embodiment is a modification of the first embodiment.

In the third embodiment, a transmission processing unit 60 switches between an increase and a decrease in the center frequency of each chirp signal over time according to the transmission cycle. In other words, the transmission processing unit 60 changes the sign of a slope of the center frequency variation with respect to time over an entire transmission cycle, depending on the transmission cycle. For example, as shown in FIG. 9, the transmission processing unit 60 sets the slope of the center frequency variation in a specific transmission cycle to a positive direction, and then switches the slope of the center frequency variation to a negative direction in the immediately subsequent transmission cycle.

According to the third embodiment described above, since the increase and the decrease in the center frequency of each chirp signal over time are switched according to the transmission cycle, interference with other radar devices 1 can be reduced.

### Fourth Embodiment

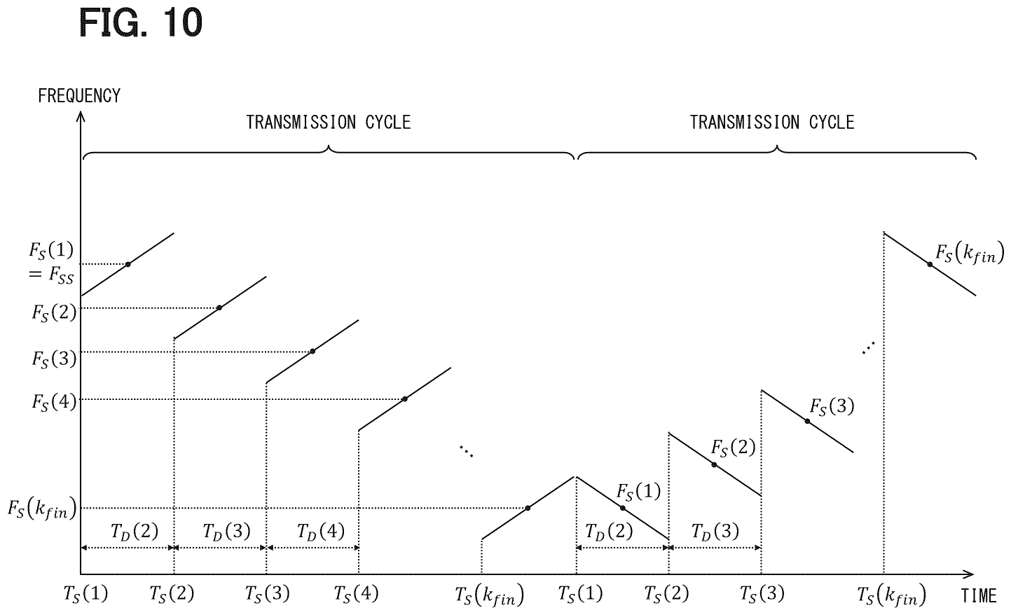

A fourth embodiment shown in FIG. 10 is a modification of the first embodiment.

A transmission processing unit 60 performs both switching between an increasing and decreasing change in the frequency over time within each chirp signal according to the transmission cycle, and switching between an increasing and decreasing change in the center frequency over time for each chirp signal according to the transmission cycle. For example, as shown in FIG. 10, in a specific transmission cycle, the transmission processing unit 60 sets a slope of the frequency variation for each chirp signal to a positive direction, and a slope of the center frequency variation to a negative direction. Then, in the immediately following transmission cycle, the transmission processing unit 60 switches the slope of the frequency variation for each chirp signal to the negative direction and the slope of the center frequency variation to the positive direction.

### Fifth Embodiment

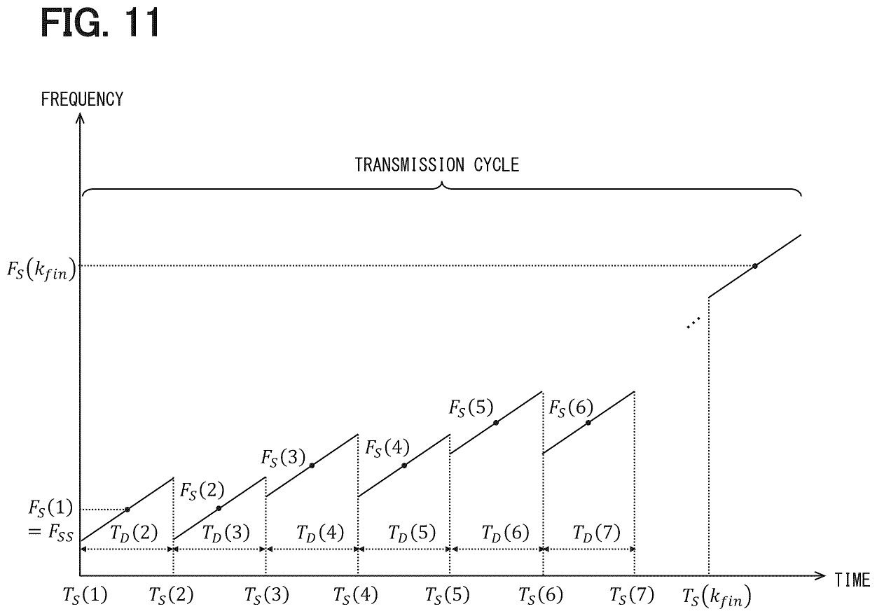

A fifth embodiment shown in FIG. 11 is a modification of the first embodiment.

In the fifth embodiment, a transmission processing unit 60 sets a time interval and a center frequency of the chirp signals within a transmission cycle so that they vary for each set of multiple chirp signals. In an example shown in FIG. 11, the transmission processing unit 60 is configured so that the time interval and the center frequency change for every two consecutive sets of chirp signals.

According to the fifth embodiment described above, the center frequency and the time interval change not for each individual chirp signal, but for each set of multiple chirp signals. As a result, compared to a case where parameters are changed for each individual chirp signal, it becomes possible to adjust the time interval in smaller increments. For example, when a minimum time interval that can be set by the control unit 6 is 10 ns, it is possible to achieve adjustment in 5 ns increments by changing the interval every other time. When there is a difference between the required time interval and the implementable time interval, it becomes possible to achieve finer control of the time interval by varying the interval for each set of multiple chirp signals, as described above.

### Other Embodiments

Although a plurality of embodiments have been described above, the present disclosure is not to be construed as being limited to these embodiments, and can be applied to various embodiments and combinations within a scope not deviating from the gist of the present disclosure.

In a modification, a time interval T_{D}(k) may be an interval between representative times within the chirp signal, rather than the transmission start time point. The representative times other than the transmission start time point may include, for example, the transmission end time point of the chirp signal or the time at which the frequency becomes the center frequency F_{S}(k).

In a modification, a direction of change in the relative rate of change of the subsequent chirp signal to the preceding chirp signal in each transmission cycle may be only in a positive direction.

In a modification, parameters other than the time interval T_{D}(k) and the center frequency F_{S}(k) of the chirp signal may be modified as appropriate. Furthermore, the preceding chirp signal and the subsequent chirp signal may be temporally separated, or they may partially overlap in time.

In a modification, the radar device 1 may perform so-called CDM (Code Division Multiplex) modulation, in which a random component is superimposed on the phase of the transmitted chirp signal for each of transmission antennas TX.

In a modification, the radar device 1 may perform so-called DDM (Doppler Division Multiplex) modulation, in which a linear component is superimposed on the phase of the transmitted chirp signal for each of the transmission antennas TX.

In a modification, the moving object to which the radar device 1 is applied may be, for example, an autonomous robot capable of transporting luggage or collecting information by autonomous driving or remote driving. The autonomous robot includes an autonomous vehicle.

The embodiments and modifications described above may be implemented as a controller that is configured to be mountable on a host mobile body and has at least one processor 6a and at least one memory 6b. Specifically, the above-described embodiment and modified examples may be implemented in the form of a processing circuit (e.g., a processing ECU) or a semiconductor device (e.g., a semiconductor chip).

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A radar device comprising:
at least one of (i) a circuit and (ii) a processor with a memory storing computer program code executable by the processor, the at least one of the circuit and the processor configured to cause the radar device to:
implement, in each transmission cycle, a first transmission of signal sets, each of the signal sets including at least one chirp signal whose frequency varies over time;
implement a second transmission of the signal sets such that, for each signal set, a center frequency of the chirp signal monotonically changes, and a time interval between the signal sets linearly varies over time; and
acquire reception data of a reflected signal, the reflected signal being the chirp signal that has been reflected by a target in an external environment, wherein
a relative rate of change in the center frequency with respect to a reference frequency is a frequency rate of change,
a relative rate of change in the time interval with respect to a reference interval is a time rate of change,
a relative rate of change in the time rate of change with respect to the frequency rate of change is a ratio change rate, and
the second transmission includes adjusting the center frequency for each signal set so that the ratio change rate falls within an allowable range during a specific time period.

2. The radar device according to claim 1, wherein
a direction of variation of the ratio change rate, in each transmission cycle, from a subsequent signal set to a preceding signal set is only in one direction, either positive or negative.

3. The radar device according to claim 1, wherein
the at least one of the circuit and the processor is further configured to cause the radar device to transmit the signal sets by switching, in accordance with the transmission cycle, between an increasing change and a decreasing change in the frequency of the chirp signal over time.

4. The radar device according to claim 1, wherein
the at least one of the circuit and the processor is further configured to cause the radar device to transmit the signal sets by switching, in accordance with the transmission cycle, between an increasing change and a decreasing change in the center frequency of the chirp signal for each signal set over time.

5. The radar device according to claim 1, wherein
the at least one of the circuit and the processor is further configured to cause the radar device to transmit a single chirp signal for each signal set.

6. The radar device according to claim 1, wherein
the at least one of the circuit and the processor is further configured to cause the radar device to transmit a plurality of chirp signals for each signal set.

7. A radar control method comprising:
first transmitting, in each transmission cycle, signal sets, each of the signal sets including at least one chirp signal whose frequency varies over time;
second transmitting the signal sets such that, for each signal set, a center frequency of the chirp signal monotonically changes and a time interval between the signal sets linearly varies over time; and
acquiring reception data of a reflected signal, the reflected signal being the chirp signal that has been reflected by a target in an external environment, wherein
a relative rate of change in the center frequency with respect to a reference frequency is a frequency rate of change,
a relative rate of change in the time interval with respect to a reference interval is a time rate of change,
a relative rate of change in the time rate of change with respect to the frequency rate of change is a ratio change rate, and
the second transmitting includes adjusting the center frequency for each signal set so that the ratio change rate is within an allowable range during a specific time period.

8. A non-transitory computer readable medium storing a computer program product comprising instructions configured to, when executed by at least one of (i) a circuit and (ii) a processor, cause the at least one of the circuit and the processor to:
implement, in each transmission cycle, a first transmission of signal sets, each of the signal sets including at least one chirp signal whose frequency varies over time;
implement a second transmission of the signal sets such that, for each signal set, a center frequency of the chirp signal monotonically changes, and a time interval between the signal sets linearly varies over time; and
acquire reception data of a reflected signal, the reflected signal being the chirp signal that has been reflected by a target in an external environment, wherein
a relative rate of change in the center frequency with respect to a reference frequency is a frequency rate of change,
a relative rate of change in the time interval with respect to a reference interval is a time rate of change,
a relative rate of change in the time rate of change with respect to the frequency rate of change is a ratio change rate, and
the second transmission includes adjusting the center frequency for each signal set so that the ratio change rate is within an allowable range during a specific time period.
